(19) United States
(12) Patent Application Publication
(10) Pub. No.: US 2025/0111383 A1
(43) Pub. Date: Apr. 3, 2025

(54) METHODS AND INTERNET OF THINGS (IOT) SYSTEMS FOR SMART GAS EMERGENCY SAFETY SIMULATION BASED ON GOVERNMENT REGULATION

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Lei HE, Chengdu (CN); Siwei ZENG, Chengdu (CN)

(73) Assignee: CHENGDU QINCHUAN IOT TECHNOLOGY CO., LTD., Chengdu (CN)

(21) Appl. No.: 18/977,885

(22) Filed: Dec. 11, 2024

(30) Foreign Application Priority Data
Oct. 11, 2024 (CN) 202411412350.9

(51) Int. Cl. G06Q 30/018; G06Q 10/0637; G06Q 10/067; G16Y 40/35

(52) U.S. Cl. CPC G06Q 30/018; G06Q 10/06375; G06Q 10/067; G16Y 40/35

(57) ABSTRACT

Methods, Internet of Things (IoT) systems, and storage mediums for smart gas emergency safety simulation based on government regulation are provided. The method may be implemented by the IoT system for smart gas emergency safety simulation based on government regulation. The method may include: predicting, by a gas company management platform, potential emergency hazards of a plurality of regulatory regions based on obtained gas regulatory information of the plurality of regulatory regions, determining, based on hazard feedback information corresponding to the potential emergency hazards and the gas regulatory information, emergency safety simulation parameters corresponding to the plurality of regulatory regions; sending the emergency safety simulation parameters to a gas user platform and sending emergency safety simulation notifications to emergency safety simulation personnel; and determining an emergency safety simulation result corresponding to the emergency safety simulation parameters based on simulation monitoring data.

### CROSS-REFERENCE TO RELATED APPLICATION

This application claims priority to Chinese Patent Application No. 202411412350.9, filed on Oct. 11, 2024, the entire contents of which are hereby incorporated herein by reference.

### TECHNICAL FIELD

The present disclosure relates to the field of emergency safety simulation, and in particular, to methods and Internet of Things (IoT) systems for smart gas emergency safety simulation based on government regulation.

### BACKGROUND

In the daily management of gas operations, gas companies need to carry out emergency safety simulation drills in order to improve the emergency safety management system and the emergency disposal technology. Gas companies often implement emergency safety simulation drills in different regulatory regions based on preset plans. Gas companies develop different emergency drill plans for different scenarios (e.g., fire drills in residential regions and emergency drills at gas gate stations). However, preset plans often ignore different potential hazards that may exist between similar scenarios in the different regulatory regions, as well as different environments and layouts of the same type of gas ancillary facilities (e.g., gas regulator stations) or the same type of gas-related companies in different regulatory regions, resulting in poor emergency safety simulation drills.

Therefore, it is desirable to provide methods and Internet of Things (IoT) systems for smart gas emergency safety simulation based on government regulation, which can determine, according to gas regulatory information of the regulatory regions, the parameters of the warning device in a targeted manner for the emergency safety simulation drills in the different regulatory regions, so as to make the emergency safety simulation drill process conform to the actual scenario and make the drill effect better satisfy the actual demand.

### SUMMARY

One or more embodiments of the present disclosure provide a method for smart gas emergency safety simulation based on government regulation. The method may be implemented by an Internet of Things (IoT) system for smart gas emergency safety simulation based on government regulation. The IoT system may include a gas company management platform, a gas company service platform, a gas equipment object platform, a gas user platform, and a government regulatory management platform. The method may include: obtaining, by the gas company management platform, gas regulatory information of a plurality of regulatory regions through the gas equipment object platform; predicting, by the gas company management platform, potential emergency hazards of the plurality of regulatory regions based on the gas regulatory information, and sending the potential emergency hazards to the gas user platform through the gas company service platform; obtaining, by the gas company management platform, hazard feedback information corresponding to the potential emergency hazards through the gas user platform; determining, by the gas company management platform, emergency safety simulation parameters corresponding to the plurality of regulatory regions based on the hazard feedback information and the gas regulatory information, the emergency safety simulation parameters including arrangement parameters of emergency safety simulation personnel and operation parameters of emergency safety simulation equipment in the plurality of regulatory regions; sending, by the gas company management platform, the emergency safety simulation parameters to the gas user platform to instruct the gas user platform to adjust the operation parameters of the emergency safety simulation equipment and sending emergency safety simulation notifications to the emergency safety simulation personnel through the emergency safety simulation equipment; obtaining, by the gas company management platform, simulation monitoring data collected by the emergency safety simulation equipment through the gas equipment object platform, the emergency safety simulation equipment performing an emergency safety simulation process; determining, by the gas company management platform, an emergency safety simulation result corresponding to the emergency safety simulation parameters based on the simulation monitoring data, and sending the emergency safety simulation result to the government regulatory management platform. The government regulatory management platform may determine parameter optimization data of warning devices based on the emergency safety simulation result and the potential emergency hazards, and send the parameter optimization data to gas companies corresponding to the plurality of regulatory regions to instruct the gas companies to adjust parameters of the warning devices in the plurality of regulatory regions.

One or more embodiments of the present disclosure provides an Internet of Things (IoT) system for smart gas emergency safety simulation based on government regulation. The IoT system may include a gas company management platform, a gas company service platform, a gas equipment object platform, a gas user platform, a government regulatory management platform, a government regulatory object platform, a government regulatory sensing network platform, and a gas company sensing network platform. The government regulatory object platform may include the gas company management platform. The IoT system may be configured to perform the method for smart gas emergency safety simulation based on government regulation.

One or more embodiments of the present disclosure provide a non-transitory computer-readable storage medium storing computer instructions. When reading the computer instructions in the storage medium, a computer may execute the method for smart gas emergency safety simulation based on government regulation.

### BRIEF DESCRIPTION OF THE DRAWINGS

The present disclosure will be further illustrated by way of exemplary embodiments. These exemplary embodiments will be described in detail by way of drawings. These embodiments are non-limiting exemplary embodiments, in which like reference numerals represent similar structures, wherein:

FIG. 1 is a schematic diagram illustrating an Internet of Things (IoT) system for smart gas emergency safety simulation based on government regulation according to some embodiments of the present disclosure;

FIG. 2 is a flowchart illustrating an example process for simulating smart gas emergency safety based on government regulation according to some embodiments of the present disclosure;

FIG. 3 is a flowchart illustrating an exemplary process for determining emergency safety simulation parameters corresponding to a plurality of regulatory regions according to some embodiments of the present disclosure;

FIG. 4 is an exemplary schematic diagram illustrating predicting potential emergency hazards of a plurality of regulatory regions according to some embodiments of the present disclosure; and

FIG. 5 is a flowchart illustrating an exemplary process for determining parameter optimization data of warning devices according to some embodiments of the present disclosure.

### DETAILED DESCRIPTION

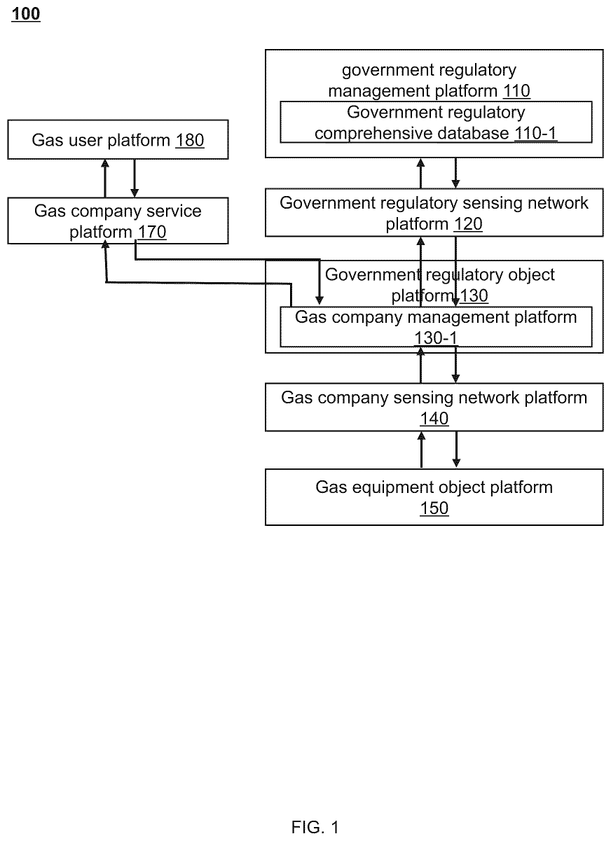

FIG. 1 is a schematic diagram illustrating an Internet of Things (IoT) system for smart gas emergency safety simulation based on government regulation according to some embodiments of the present disclosure. It should be noted that the following embodiments are merely provided to illustrate the present disclosure and do not constitute a limitation of the present disclosure.

As shown in FIG. 1, the Internet of Things (IoT) system 100 for smart gas emergency safety simulation based on government regulation may include a government regulatory management platform 110, a government regulatory sensing network platform 120, a government regulatory object platform 130, a gas company sensing network platform 140, a gas equipment object platform 150, a gas company service platform 170, and a gas user platform 180.

The government regulatory management platform 110 refers to a platform for the government to carry out regulatory management

In some embodiments, the government regulatory management platform 110 may include a government regulatory comprehensive database 110-1. The government regulatory comprehensive database 110-1 refers to a database that stores government regulatory data.

In some embodiments, the government regulatory management platform 110 may be further configured to determine, based on emergency safety simulation results and potential emergency hazards of a plurality of regulatory regions, parameter optimization data of warning devices, and send the parameter optimization data to gas companies corresponding to the plurality of regulatory regions to instruct the gas companies to adjust parameters of the warning devices of the plurality of regulatory regions.

The government regulatory sensing network platform 120 refers to a connection platform that realizes interaction between the government regulatory management platform 110 and the government regulatory object platform 130, and may be configured to be a communication network and gateway.

In some embodiments, the government regulatory sensing network platform 120 may interact with the government regulatory comprehensive database 110-1 and a gas company management platform 130-1. For example, the gas company management platform 130-1 may upload the emergency safety simulation results to the government regulatory sensing network platform 120.

The government regulatory object platform 130 refers to a functional platform for generating perceptual information and executing control information.

In some embodiments, the government regulatory object platform 130 may interact with the government regulatory sensing network platform 120, the gas company sensing network platform 140, and the gas company service platform 170 for information exchange.

In some embodiments, the government regulatory object platform 130 may include the gas company management platform 130-1. The gas company management platform 130-1 may include a processor.

The gas company management platform 130-1 refers to a platform for generating perceptual information and executing control information.

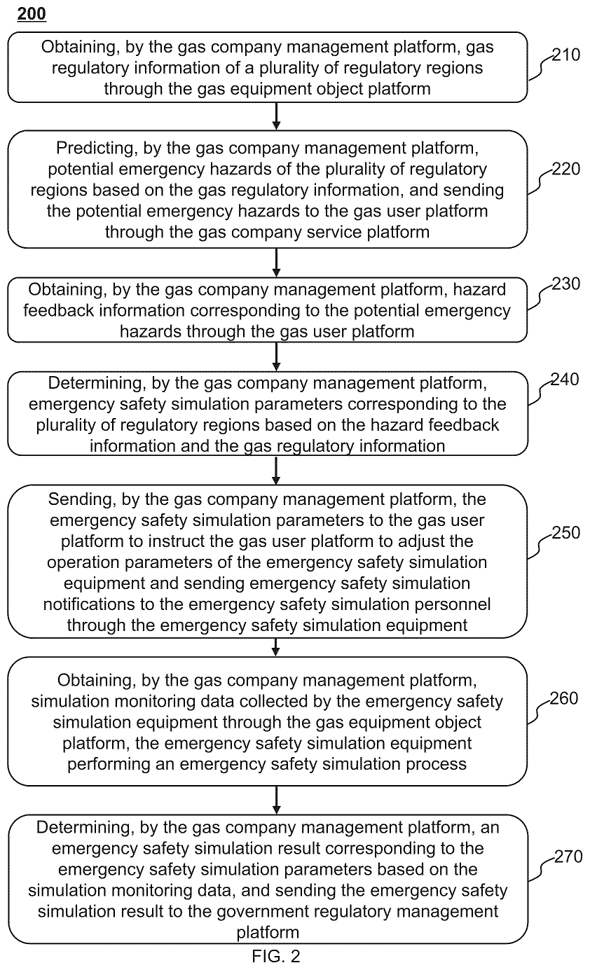

In some embodiments, the gas company management platform 130-1 may be configured to perform operation 210 to operation 270 of a method for smart gas emergency safety simulation based on government regulation. More descriptions may be found in FIG. 2.

In some embodiments, the emergency safety simulation equipment is communicatively connected to the gas equipment object platform 150.

The gas company sensing network platform 140 refers to a connection platform that realizes interaction between the gas company management platform 130-1 and the gas equipment object platform 150, and may be configured to be a communication network and gateway. For example, the gas company sensing network platform 140 may send gas regulatory information of the plurality of regulatory regions obtained by the gas equipment object platform to the gas company management platform.

In some embodiments, the gas company sensing network platform 140 may be configured to interact with the gas equipment object platform and the gas company management platform.

The gas equipment object platform 150 refers to a functional platform that senses and generates information, and controls execution of information.

In some embodiments, the gas equipment object platform 150 may be configured to obtain uploaded data of a plurality of gas ancillary facilities, and uploaded data of a gas monitoring device installed in a gas pipeline segment.

The gas ancillary facilities refer to ancillary facilities of the gas pipeline, such as valves.

In some embodiments, the gas ancillary facilities may include a pipeline regulating device.

The pipeline regulating device refers to a device configured to regulate gas pressure, flux, etc. of a gas pipeline. For example, the pipeline regulating device may include a valve, a pressure regulator, a gas detector, or the like, or any combination thereof.

The gas monitoring device refers to a device configured to monitor gas data in a gas pipeline.

The gas monitoring device may include a gas pressure monitoring device, a temperature monitoring device, a flow monitoring device, or the like, or any combination thereof.

The gas equipment object platform 150 refers to a functional platform that senses and generates information related to emergency simulation components, and controls execution of information.

In some embodiments, the gas equipment object platform 150 may be configured to be communicatively connected to the emergency safety simulation equipment and upload status information of the emergency safety simulation equipment and simulation monitoring data collected by the emergency safety simulation equipment to the gas company management platform 130-1.

The emergency safety simulation equipment refers to components used during an emergency safety simulation drill in the regulatory region. The emergency safety simulation drill may include a fire simulation drill in a residential region, an emergency safety simulation drill in a gas gate station, etc. In some embodiments, the emergency safety simulation equipment may include an alarm device, a smoke generator, an emergency indication device, a gas leakage simulation device, a firefighting device, a prompting device, a monitoring device, or the like, or any combination thereof.

In some embodiments, the emergency safety simulation equipment may be installed in relevant gas companies, the gas ancillary facilities, and gas pipeline segments in the regulatory region.

The gas company service platform 170 refers to a platform configured to receive and transmit data and/or information.

In some embodiments, the gas company service platform 170 may be configured to interact with the gas company management platform 130-1 and the gas user platform 180.

The gas user platform 180 refers to a platform that interacts with a gas user.

In some embodiments, the gas user platform 180 may be configured to be on a relevant gas company and the emergency safety simulation equipment corresponding to the relevant gas company. The gas user platform may be configured to receive the potential emergency hazards and emergency safety simulation parameters issued by the gas company service platform 170.

In some embodiments, the gas user platform 180 may also be configured to obtain hazard feedback information of the potential emergency hazards and upload the hazard feedback information to the gas company management platform 130-1. In some embodiments, the gas user platform 180 may also be configured to adjust operation parameters of the emergency safety simulation equipment based on the emergency safety simulation parameters, and send emergency safety simulation notifications to the emergency safety simulation personnel through the emergency safety simulation equipment.

More descriptions of the platforms involved in the Internet of Things (IoT) system 100 for smart gas emergency safety simulation based on government regulation may be found in the relevant descriptions in FIGS. 2-5 of the present disclosure.

FIG. 2 is a flowchart illustrating an example process for smart gas emergency safety simulation based on government regulation according to some embodiments of the present disclosure. In some embodiments, the process 200 may be performed by the Internet of Things (IoT) system 100 for smart gas emergency safety simulation based on government regulation. As shown in FIG. 2, the process 200 may include operation 210 to operation 270 described below.

In 210, gas regulatory information of a plurality of regulatory regions may be obtained by the gas company management platform through the gas equipment object platform.

More descriptions regarding the gas company management platform and the gas equipment object platform may be found in the relevant descriptions of FIG. 1.

The regulatory regions refer to gas regulatory regions for which gas companies are responsible. The regulatory regions may be specified by those skilled in the art according to actual needs.

The gas regulatory information refers to various information obtained in the gas regulatory process.

In some embodiments, the gas regulatory information may include at least one of operation parameters of gas facilities, gas data, inspection and maintenance information, or status information of the emergency safety simulation equipment.

More descriptions regarding the gas ancillary facilities, pipeline regulating devices, and gas monitoring devices may be found in the descriptions of FIG. 1.

In some embodiments, the operation parameters of gas ancillary facilities may include operation parameters of the pipeline regulating devices and/or monitoring parameters of the gas monitoring devices.

In some embodiments, the operation parameters of the pipeline regulating devices may include at least one of an opening size of a valve, a pressure adjustment range of a pressure regulator, a monitoring frequency of a gas detector, etc.

In some embodiments, the monitoring parameters of the gas monitoring devices may include a monitoring frequency of at least one of a gas pressure monitoring device, a temperature monitoring device, a flow monitoring device, etc.

In some embodiments, the gas company management platform may obtain operation parameters of the gas facilities through the gas equipment object platform.

The gas data refer to data related to gas in a gas pipeline. The gas data may include a gas pressure value, a temperature value, and a gas flow value in the gas pipeline.

In some embodiments, the gas company management platform may obtain the gas data through the gas equipment object platform.

The inspection and maintenance information refers to inspection and maintenance data of the regulatory regions. For example, the inspection and maintenance information may include information about the inspection and maintenance records of the gas pipelines of the regulatory regions.

In some embodiments, the gas company management platform may obtain the inspection and maintenance information from the gas equipment object platform through the gas company sensing network platform.

More descriptions regarding the emergency safety simulation equipment may be found in the related description of FIG. 1.

In some embodiments, the status information of the emergency safety simulation equipment may include whether the emergency safety simulation equipment is enabled, whether the emergency safety simulation equipment is normally enabled, and operation parameters of the emergency safety simulation equipment at the current moment.

The operation parameters of the emergency safety simulation equipment at the current moment may include a sound intensity of an alarm device at the current moment, a brightness of an emergency indication device at the current moment, a monitoring clarity level of a monitoring device at the current moment, etc.

In some embodiments, the gas company management platform may obtain the status information of the emergency safety simulation equipment from the gas equipment object platform through the gas company sensing network platform.

In 220, potential emergency hazards of the plurality of regulatory regions may be predicted by the gas company management platform based on the gas regulatory information, and the potential emergency hazards may be sent to the gas user platform through the gas company service platform.

More descriptions regarding the gas company service platform and the gas user platform may be found in the descriptions of FIG. 1.

The potential emergency hazards refer to possible safety hazards.

In some embodiments, the potential emergency hazards may include a first potential emergency hazard and a second potential emergency hazard.

The first potential emergency hazard refers to a potential emergency hazard caused by the status information of the emergency safety simulation equipment or by a long interval between inspection and maintenance.

In some embodiments, the gas company management platform may determine the first potential emergency hazard by analyzing the inspection and maintenance information or the status information of the emergency safety simulation equipment of the gas regulatory information.

For example, if the gas company management platform shows, by analyzing the inspection and maintenance information in the gas regulatory information, that a certain emergency safety simulation equipment changes from a normal on-state to an abnormal off-state, or the gas company management platform determines, by analyzing the status information of the gas valve, that a time interval between a certain gas valve from a time point of the last inspection and maintenance and a current time point exceeds a preset time threshold, the emergency safety simulation equipment or the gas valve may be the first potential emergency hazard.

The preset time threshold refers to a critical value of the interval time. The preset time threshold may be preset by a person skilled in the art according to experience.

The second potential emergency hazard refers to an emergency potential hazard obtained based on the analysis of the operation parameters of the gas facilities and the gas data.

In some embodiments, the gas company management platform may determine the second potential emergency hazard using a preset analysis manner based on time-series data of the operation parameters of the gas facilities and the gas data. The preset analysis manner may include a trend analysis manner, etc.

The gas company management platform may analyze a trend line of the operation parameters of the gas facilities and/or the gas data in the time series through the trend analysis manner. In response to the existence of a point at which a sudden change occurs on the trend line, it may indicate that the gas facilities have the second potential emergency hazard.

The time series refers to a series of a plurality of time points. The trend line of the operation parameters of the gas facilities in the time series refers to a curve that is plotted by arranging the operation parameters of a plurality of gas facilities in chronological order.

The trend line of the gas data in the time series refers to another curve plotted by arranging a plurality of pieces of gas data in chronological order.

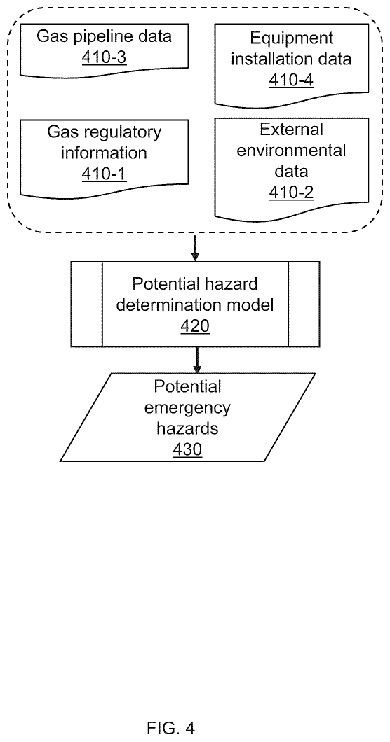

In some embodiments, the gas company management platform may also determine the potential emergency hazards using the method shown in FIG. 4. More descriptions may be found in FIG. 4.

In some embodiments, the gas company management platform may send the potential emergency hazards to the gas user platform through the gas company service platform based on the network. The gas user platform may send the potential emergency hazards to gas companies corresponding to the potential emergency hazards. The gas companies may send corresponding maintenance personnel to confirm whether there are the predicted potential emergency hazards on site, and rectify the potential emergency hazards that do exist.

In 230, hazard feedback information corresponding to the potential emergency hazards may be obtained by the gas company management platform through the gas user platform.

The hazard feedback information refers to information related to the potential emergency hazards that is fed back from the gas user platform to the gas company management platform.

For example, the hazard feedback information may include that the gas user platform agrees with the potential emergency hazards determined by the gas company management platform, whether the potential emergency hazards determined by the gas company management platform are rectified, etc.

In some embodiments, the gas company management platform may obtain the hazard feedback information corresponding to different potential emergency hazards of relevant gas companies through the gas user platform. The relevant gas companies refer to companies responsible for gas management of regulatory regions.

In 240, emergency safety simulation parameters corresponding to the plurality of regulatory regions may be determined by the gas company management platform based on the hazard feedback information and the gas regulatory information.

The emergency safety simulation parameters refer to parameters related to an emergency safety simulation drill of the regulatory region.

In some embodiments, the emergency safety simulation parameters may include arrangement parameters of emergency safety simulation personnel and operation parameters of the emergency safety simulation equipment of the plurality of regulatory regions.

The emergency safety simulation personnel refer to personnel who participate in the emergency safety simulation drill of the regulatory region. For example, the emergency safety simulation personnel may include patrol personnel, maintenance personnel, etc.

In some embodiments, the arrangement parameters of the emergency safety simulation personnel may include whether the emergency safety simulation personnel participate in the emergency safety simulation drill of the regulatory region, a count of emergency safety simulation personnel participating in the emergency safety simulation drill of the regulatory region, a count of emergency safety simulation personnel assigned to each sub-region (or a certain post) of the regulatory regions, etc. The sub-region refers to a portion of the regulatory region.

The various sub-regions in the regulatory region may be divided in advance by those skilled in the art based on experience. For example, a region in which a gas ancillary facility is located may be divided into a sub-region, a gas pipeline segment may be divided into a sub-region, etc.

In some embodiments, the gas company management platform may determine, based on the hazard feedback information, the count of sub-regions with the potential emergency hazards, and evenly distribute, based on the count of sub-regions with the potential emergency hazards and the total count of emergency safety simulation personnel of the regulatory regions at the current moment, the count of emergency safety simulation personnel for each sub-region with the potential emergency hazards.

The operation parameters of the emergency safety simulation equipment refer to parameters related to the operation of the emergency safety simulation equipment. For example, the operation parameters of the emergency safety simulation equipment may include a smoke concentration, an on-time, and an off-time of a smoke generator. As another example, the operation parameters of the emergency safety simulation equipment may include a sound intensity, an on-time, and an off-time of the alarm device.

In some embodiments, the operation parameters of the emergency safety simulation equipment may include a simulated alarm level, a simulated alarm type, etc. of the emergency safety simulation equipment. The simulated alarm level refers to an alarm level used by the emergency safety simulation equipment during the emergency safety simulation drill. The simulated alarm type refers to a type of alarm used by the emergency safety simulation equipment during the emergency safety simulation drill.

In some embodiments, the gas company management platform may calculate, based on the gas regulatory information, an average value of operation parameters of historical emergency safety simulation equipment of the sub-regions, and take the average value of the historical emergency safety simulation equipment of the sub-regions as the operation parameters of the emergency safety simulation equipment of the sub-regions at the current moment.

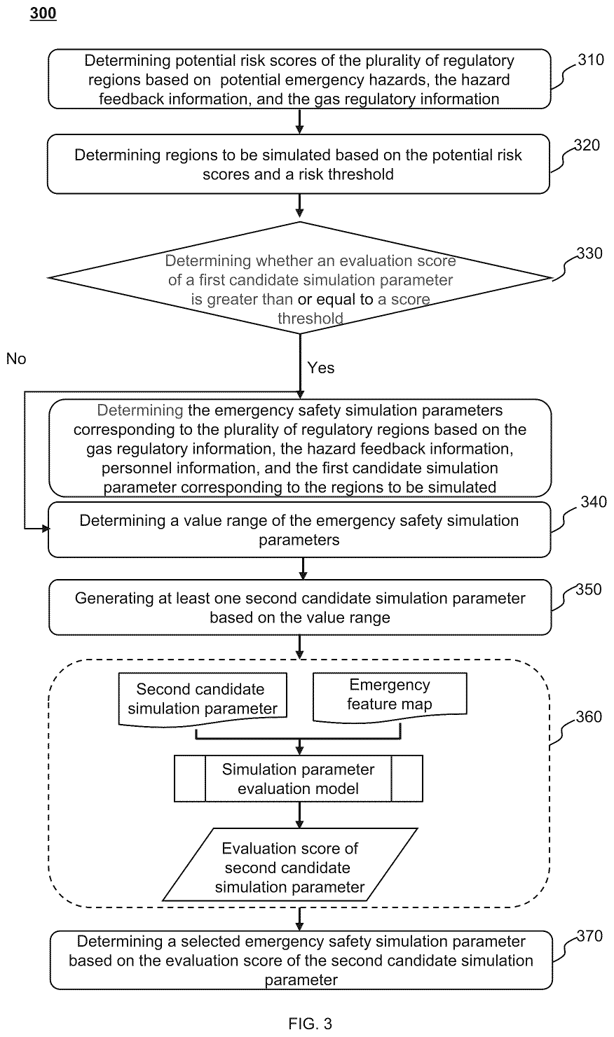

In some embodiments, the gas company management platform may also determine the emergency safety simulation parameters corresponding to the plurality of regulatory regions using the method shown in FIG. 3. More descriptions may be found in FIG. 3.

In 250, the emergency safety simulation parameters may be sent to the gas user platform to instruct the gas user platform to adjust the operation parameters of the emergency safety simulation equipment and emergency safety simulation notifications may be sent to the emergency safety simulation personnel through the emergency safety simulation equipment by the gas company management platform.

In some embodiments, the gas company management platform may send the emergency safety simulation parameters to the gas user platform to instruct the gas user platform to adjust values of the operation parameters of the emergency safety simulation equipment as values corresponding to the emergency safety simulation parameters.

The emergency safety simulation notifications refer to notifications that the emergency safety simulation personnel need to participate in an emergency safety simulation. The emergency safety simulation notifications may include a voice notification or a text notification of the emergency safety simulation personnel who need to participate in the emergency safety simulation drill, a position of the emergency safety simulation drill, post information of the emergency safety simulation drill, etc.

In some embodiments, the gas company management platform may send the emergency safety simulation notifications to the emergency safety simulation personnel through the emergency safety simulation equipment (e.g., a prompting device near the emergency safety simulation personnel).

In 260, simulation monitoring data collected by the emergency safety simulation equipment through the gas equipment object platform may be obtained by the gas company management platform, the emergency safety simulation equipment performing an emergency safety simulation process.

In some embodiments, the emergency safety simulation process may include a fire simulation drill process in a residential neighborhood, an emergency safety simulation drill process at a gas gate station, etc.

In some embodiments, the simulation monitoring data may include at least one of implementation of personnel evacuation, implementation of emergency means, and implementation of hedging means, or smoke duration.

The implementation of personnel evacuation refers to implementation of personnel evacuation from a scene of an emergency situation (e.g., fire). The implementation of the emergency means refers to implementation of a series of measures and actions taken in response to an emergency situation (e.g., fire). The implementation of the hedging means refers to implementation of the means of avoiding dangers. Understandably, the better the implementation of the personnel evacuation, the implementation of the emergency means, and the implementation of the hedging means are, the more the impact of emergencies on people, property, and the environment may be reduced.

In some embodiments, the gas company management platform may obtain, through the gas equipment object platform, the simulation monitoring data collected by the emergency safety simulation equipment (e.g., a monitoring device, a smoke sensor, etc.) that performs the emergency safety simulation process, or the simulation monitoring data identified and collected by radio frequency identification (RFID) electronic tags carried by the emergency safety simulation equipment.

For example, the gas company management platform may obtain, through the gas equipment object platform, the smoke duration collected by the smoke sensor that conducts the emergency safety simulation process.

In 270, an emergency safety simulation result corresponding to the emergency safety simulation parameters may be determined based on the simulation monitoring data, and the emergency safety simulation result may be sent to the government regulatory management platform by the gas company management platform.

In some embodiments, the simulation monitoring data may also include a personnel response time, a hazard detection time, a personnel evacuation time, and a simulated rescue and repair time. The personnel response time refers to a total time from receiving an emergency alarm to completing troubleshooting and personnel scheduling. The hazard detection time refers to a total time from an occurrence of a fault to the troubleshooting and discovery of the fault. The personnel evacuation time refers to a time point when personnel are evacuated. The simulated rescue and repair time refers to a time point when the simulated rescue and repair of the fault begins. More descriptions regarding the simulation monitoring data may be found in the descriptions of operation 260 in FIG. 2.

In some embodiments, the emergency safety simulation result may include at least one of a response time of troubleshooting, a response time of personnel evacuation, or a response time of warning.

In some embodiments, since there may be a plurality of different related gas companies, a plurality of gas ancillary facilities, and a plurality of gas pipeline segments in a single regulatory region, the emergency safety simulation result may include at least one of the emergency safety simulation results of the related gas companies, the emergency safety simulation results of the gas ancillary facilities, or the emergency safety simulation results of the gas pipeline segments.

More descriptions regarding the related gas companies may be found in the descriptions of operation 230. The gas pipeline segment refers to a section of gas pipeline in the regulatory region. In some embodiments, the gas company may obtain a plurality of gas pipeline segments by dividing, based on actual needs, the gas pipeline in the regulatory region into the plurality of segments in advance.

In some embodiments, the gas company management platform may determine, based on the simulation monitoring data, the emergency safety simulation result corresponding to the emergency safety simulation parameters.

In some embodiments, the gas company management platform may send the determined emergency safety simulation result to the government regulatory management platform through the government regulatory sensing network platform.

In some embodiments, the government regulatory management platform may determine parameter optimization data of the warning devices based on the emergency safety simulation result and the potential emergency hazards, and send the parameter optimization data to gas companies corresponding to the plurality of regulatory regions to instruct the gas companies to adjust parameters of the warning devices in the plurality of regulatory regions.

More descriptions regarding the government regulatory management platform may be found in the related descriptions of FIG. 1.

The warning devices refer to various monitoring devices, notification devices, alarm devices, or indication devices screened out from the gas ancillary facilities and the emergency safety simulation equipment. For example, the warning devices may include a gas data monitoring device, a safety monitoring device, an alarm device, an emergency indication device, or the like, or any combination thereof. The safety monitoring device may be configured to monitor the safety of personnel. The safety monitoring device may include a monitoring device, etc.

The parameter optimization data of the warning devices refer to data used to optimize parameters of the warning device.

In some embodiments, the parameter optimization data of the warning device may include adjusting a warning level of the warning device.

The warning level may be configured to adjust a simulated alarm level of the corresponding warning device. The warning level may be positively correlated with the simulated alarm level of the corresponding warning device. The adjusting the warning level of the warning device may include adjusting the operation parameters (e.g., monitoring frequency, operating power, etc.) of the warning device.

In some embodiments, the parameter optimization data of the warning device may also include adjusting the arrangement parameters of the emergency safety simulation personnel, a scope of the emergency safety simulation drill, etc. The scope of the emergency safety simulation drill refers to a scope of a region where the emergency safety simulation drill is conducted. For example, the scope of the emergency safety simulation drill may include one of sub-region 1, sub-region 1+sub-region 2, etc.

In some embodiments, the government regulatory management platform may determine, based on the emergency safety simulation result, a quality of emergency safety simulation, determine, based on the potential emergency hazards, a quality threshold of emergency safety simulation corresponding to the potential emergency hazards, and determine, based on the quality threshold of emergency safety simulation and the quality of emergency safety simulation, the parameter optimization data of the warning device.

The quality of emergency safety simulation may reflect a quality of the emergency safety simulation result of each sub-region of the regulatory region. The quality of emergency safety simulation may be a numerical value within 0-100. The smaller the numerical value is, the better the quality of emergency safety simulation may be.

In some embodiments, the gas company management platform may determine the quality of emergency safety simulation of the sub-region by performing a weighted summation on the response time of the personnel evacuation, the response time of troubleshooting, and the response time of warning of the emergency safety simulation result of the sub-region.

Merely by way of example, the quality of emergency safety simulation of the sub-region may be calculated using the following first equation:

quality of emergency safety simulation C=k1*t1+k2*t2+k3*t3,

where k1, k2, and k3 are preset coefficients greater than 0 and smaller than 1, which are preset for those skilled in the art according to experience. t1 denotes the response time of troubleshooting, t2 denotes the response time of the personnel evacuation, and t3 denotes a response time of warning.

In some embodiments, the coefficients of the response time of troubleshooting, the response time of the personnel evacuation, and the response time of warning may be in turn positively related to degrees of importance to which those skilled in the art pay attention to the response time of troubleshooting, the response time of the personnel evacuation, and the response time of warning. The degree of importance of each response time in the emergency safety simulation may be preset by those skilled in the art according to experience.

The quality threshold of emergency safety simulation refers to a critical value of the quality of emergency safety simulation.

In some embodiments, the government regulatory management platform may determine, based on the potential emergency hazards, the quality threshold of emergency safety simulation corresponding to existing potential emergency hazards through a first preset comparison table.

The first preset comparison table may include a correspondence between reference potential emergency hazards and a quality threshold of emergency safety simulation corresponding to the reference potential emergency hazards. The first preset comparison table may be constructed based on priori knowledge or historical data.

In some embodiments, those skilled in the art may preset, based on a count of reference potential emergency hazards of a sub-region where the reference potential emergency hazards are located or a severity of the reference potential emergency hazards, the quality threshold of emergency safety simulation corresponding to the reference potential emergency hazards. For example, the larger the count of reference potential emergency hazards of the sub-region where the reference potential emergency hazards are located or the more severe the reference potential emergency hazards are, the smaller the quality threshold of emergency safety simulation corresponding to the reference potential emergency hazards may be set.

The existing potential emergency hazards refer to potential emergency hazards that actually existed after predicted potential emergency hazards are manually confirmed.

In some embodiments, the government regulatory management platform may determine the parameter optimization data of the warning device by comparing the quality of emergency safety simulation of each sub-region of the regulatory region to the quality threshold of emergency safety simulation respectively.

A count of improved warning levels of warning device may be positively correlated with a difference between the quality threshold of emergency safety simulation and the quality of emergency safety simulation. For example, if the difference between the quality threshold of emergency safety simulation and the quality of emergency safety simulation is 5, the warning level of the warning device may be increased by one level based on a warning level of a current warning device.

In some embodiments, the increased warning level of the warning device may include increasing the monitoring frequency of the gas data monitoring device, increasing an inspection frequency (e.g., the monitoring frequency of the gas detector) of the safety monitoring device, increasing the operating power of the warning device, etc.

The increasing the operating power of the warning device may include increasing a sound intensity of the warning device, a brightness of the emergency indication device, etc. It should be understood that the smaller the value of the quality of emergency safety simulation corresponding to the sub-region, the longer the response time in case of fault of the sub-region. Therefore, the government regulatory management platform may need to increase a monitoring intensity of the sub-region to avoid the situation where the fault cannot be detected in time. The increasing the monitoring intensity of the sub-region may include increasing the count of emergency safety simulation personnel of the sub-region, increasing the scope of the emergency safety simulation region, etc.

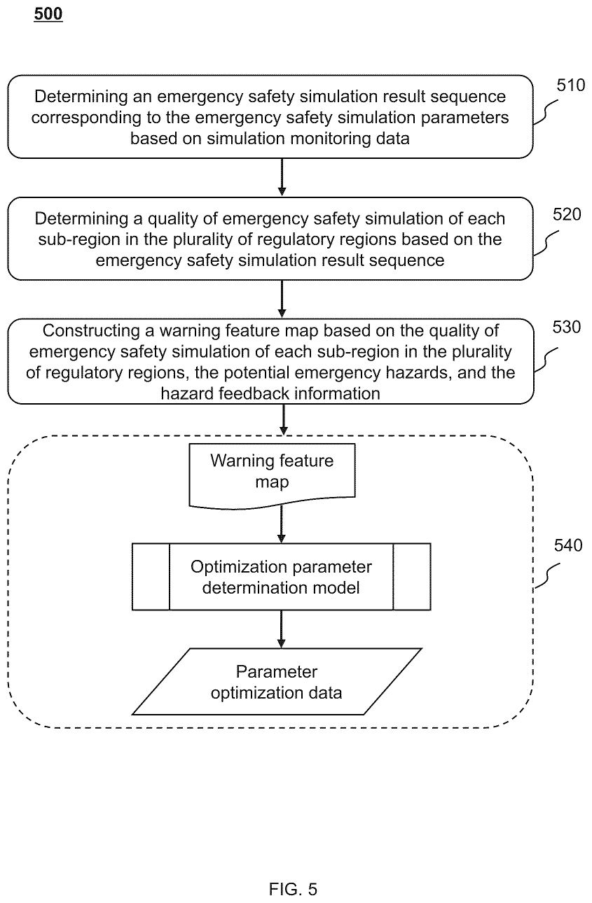

In some embodiments, the government regulatory management platform may also determine the parameter optimization data of the warning device using the method shown in FIG. 5. More descriptions may be found in FIG. 5.

In some embodiments, the government regulatory management platform may send the determined parameter optimization data of the warning device to the gas company corresponding to each regulatory region to instruct the gas company to adjust the parameters of the warning device of each regulatory region to match the determined parameter optimization data of the warning device.

According to some embodiments of the present disclosure, the gas company management platform may obtain the gas regulatory information of different regulatory regions, determine whether the potential emergency hazards exist, send, in response to the existence of the potential emergency hazards, the gas regulatory information to the corresponding gas user platform for rectification, and collect the hazard feedback information (e.g., rectification results) of the potential emergency hazards through the gas user platform. The gas company management platform may determine, based on the hazard feedback information and the gas regulatory information, the emergency safety simulation parameters of different regulatory regions, obtain a result pf the emergency simulation drill corresponding to the emergency safety simulation parameters by performing the emergency safety simulation drill, and upload the result of the emergency simulation drill to the government regulatory management platform. The government regulatory management platform may adjust and optimize the parameters of the warning device in each regulatory region based on the results of the emergency safety simulation drills in the plurality of regulatory regions as well as the potential gas hazards. Therefore, the government regulatory management platform realizes the emergency safety simulation drills in different regulatory regions and determines the parameters of the warning device in a targeted way, so that the emergency safety simulation drill process is in line with the actual scenarios, and the drill effect better meets the actual needs.

FIG. 3 is a flowchart illustrating an example process for determining emergency safety simulation parameters corresponding to a plurality of regulatory regions according to some embodiments of the present disclosure. In some embodiments, the process 300 may be performed by a gas company management platform of an IoT system for smart gas emergency safety simulation based on government regulation. As shown in FIG. 3, the process 300 may include following operation 310-operation 370.

In 310, potential risk scores of the plurality of regulatory regions may be determined based on potential emergency hazards, hazard feedback information, and gas regulatory information.

More descriptions regarding the potential emergency hazards, the hazard feedback information, and the gas regulatory information may be found in the related descriptions in FIG. 2.

The potential risk score refers to a score for the potential emergency hazards. The potential risk score may be expressed as a numerical value within 0˜100. The larger the numerical value is, the larger the potential risk score may be.

In some embodiments, the gas company management platform may determine a target feature vector based on the potential emergency hazards, the hazard feedback information, and the gas regulatory information, determine, based on the target feature vector, an associated feature vector through a vector database, and determine a reference potential risk score corresponding to the associated feature vector as the potential risk score.

The vector database may include a plurality of reference feature vectors. Each reference feature vector has a reference potential risk score corresponding to the reference feature vector. The reference feature vector refers to a feature vector constructed based on historical potential emergency hazards, historical hazard feedback information, and historical gas regulatory information.

In some embodiments, the gas company management platform may determine, based on the target feature vector, a reference feature vector that meets a preset condition in the vector database, and determine the reference feature vector that meets the preset condition as the associated feature vector. In some embodiments, the preset condition may include a vector distance from the target feature vector satisfying the preset condition, etc. The preset condition may be preset by those skilled in the art according to experience. For example, the preset condition may include the distance being smaller than a distance threshold.

In some embodiments, the gas company management platform may determine the reference potential risk score corresponding to the associated feature vector as the potential risk score.

In 320, regions to be simulated may be determined based on the potential risk scores and a risk threshold.

The risk threshold refers to a critical value of the potential risk score. The risk threshold may be preset by those skilled in the art according to experience.

In some embodiments, determining the risk threshold may be related to a historical average failure frequency of the plurality of regulatory regions.

The historical average failure frequency refers to an average of counts of historical failures across the plurality of regulatory regions.

In some embodiments, the gas company management platform may obtain, through the gas company sensing network platform, historical failure frequencies of the plurality of regulatory regions from the gas equipment object platform, and calculate an average of the historical failure frequencies of the plurality of regulatory regions as the historical average failure frequency.

In some embodiments, the gas company management platform may consider that when the historical average failure frequency in the regulatory region is relatively low, the gas operation in the region is relatively stable, and the gas company management platform may increase the risk threshold. The gas company management platform may consider that when the historical average failure frequency in the regulatory region is relatively high, the gas operation in the region is relatively unstable, and the gas company management platform may reduce the risk threshold. The specific magnitude by which the risk threshold is increased or reduced may be preset by those skilled in the art according to experience.

According to some embodiments of the present disclosure, the accuracy of a preset risk threshold may be improved by relating the determination of the risk threshold to the historical average failure frequency of the plurality of regulatory regions.

The regions to be simulated refer to regions in which the emergency safety simulation drill is conducted.

In some embodiments, the regions to be stimulated may include a high-risk region and a low-risk region. The high-risk region refers to a regulatory region with a risk score greater than or equal to the risk threshold. The low-risk region refers to a regulatory region with a risk score smaller than the risk threshold.

In some embodiments, the gas company management platform may compare the potential risk score with the risk threshold, determine the regulatory region with a risk score greater than or equal to the risk threshold as the high-risk region, and the regulatory region with a risk score smaller than the risk threshold as the low-risk region.

In some embodiments, in response to a determination that an evaluation score of a first candidate simulation parameter is greater than or equal to a score threshold, the gas company management platform may determine the emergency safety simulation parameters corresponding to the plurality of regulatory regions using operation 330 below.

In 330, the emergency safety simulation parameters corresponding to the plurality of regulatory regions may be determined by the gas company management platform based on the gas regulatory information, the hazard feedback information, personnel information, and the first candidate simulation parameter corresponding to the regions to be simulated.

The personnel information may include a count of personnel, work information of each employee, and a department to which each employee belongs. The work information may include a name, a function, a length of employment, etc. of the personnel.

In some embodiments, the gas company management platform may retrieve the personnel information from a known database through a government regulatory sensing network platform. The known database may be located in a storage of the gas company management platform or in a government regulatory comprehensive database.

The first candidate simulation parameter refers to an emergency safety simulation parameter determined based on the simulation parameter database.

In some embodiments, the gas company management platform may directly use at least one reference simulation parameter corresponding to a historically used reference emergency feature map stored in the simulation database as the first candidate simulation parameter.

An emergency feature map refers to a map constructed by the gas regulatory information, the hazard feedback information, and the personnel information corresponding to the regions to be stimulated.

In some embodiments, the emergency feature map refers to a data structure composed of nodes and edges. The edges may connect the nodes, and the nodes and the edges may have attributes.

In some embodiments, a node of the emergency feature map may correspond to a sub-region of the region to be stimulated. Those skilled in the art may obtain at least one sub-region by artificially dividing the region to be simulated in advance. For example, an region in which a gas ancillary facility is located may be divided into a sub-region, a gas pipeline segment may be divided into a sub-region, etc.

In some embodiments, a type of the node of the emergency feature map may include a first enterprise node, a first facility node, and a first pipeline node.

The first enterprise node may correspond to each relevant gas enterprise in the region to be stimulated. The first enterprise node may not correspond to a sub-region. A first enterprise node attribute may reflect personnel information of the relevant gas enterprise corresponding to the first enterprise node. For example, the first enterprise node attribute may include a count of personnel, work information of each employee, a department to which each employee belongs, etc.

The first facility node may correspond to the gas ancillary facilities in each sub-region in the region to be stimulated. The first facility node attribute may reflect a relevant feature corresponding to the gas ancillary facilities in each sub-region. For example, the first facility node attribute may include operation parameters of the gas ancillary facilities, feedback data of the sub-region corresponding to the facility node, inspection and maintenance data corresponding to gas ancillary facilities, a degree of importance of the sub-region corresponding to the facility node, etc.

The feedback data of the sub-region corresponding to the first facility node may include the potential emergency hazards, the hazard feedback information, and status information of the emergency safety simulation equipment in the sub-region corresponding to the node. The degree of importance of the sub-region corresponding to the first facility node may be preset by those skilled in the art according to experience. For example, the degree of importance of the valve may be preset to be the highest degree of importance of degrees of importance of all the facility nodes. More descriptions regarding the operation parameters of the gas ancillary facilities, the potential emergency hazards, the hazard feedback information, and the status information of the emergency safety simulation equipment may be found in the relevant descriptions in FIG. 2.

The first pipeline node may correspond to the gas pipeline segment in each sub-region in the region to be stimulated. A first pipeline node attribute may reflect a relevant feature corresponding to the gas pipeline segment in each sub-region. For example, the first pipeline node attribute may include gas data and inspection and maintenance data of the gas pipeline segment corresponding to the first pipeline node, feedback data, a degree of importance of the sub-region corresponding to the first pipeline node, etc. The inspection and maintenance data may include a position, a type, a count of times, etc. of inspection and maintenance.

In some embodiments, the gas company management platform may determine the degree of importance level the gas pipeline segment corresponding to the first pipeline node based on a historical average maintenance frequency of the gas pipeline segment corresponding to the first pipeline node. For example, the greater the historical average maintenance frequency of the sub-region corresponding to the first pipeline node, the greater the degree of importance of the gas pipeline segment corresponding to the first pipeline node.

The historical average maintenance frequency refers to an average of the maintenance frequencies of the sub-region corresponding to the pipeline node in a historical preset time period. The historical preset time period may be preset by those skilled in the art according to experience.

In some embodiments, the gas company management platform may obtain, through the gas company sensing network platform, the count of times of inspection and maintenance and a total usage time of the gas pipeline segment of the inspection and maintenance data of the gas pipeline segment corresponding to the first pipeline node from the gas equipment object platform, and determine a ratio of the count of times of inspection and maintenance to the total usage time of the gas pipeline segment as the historical average maintenance frequency.

In some embodiments, a type of the edge of the emergency feature map may include a first-type edge and a second-type edge. The first-type edge may correspond to a pathway where there is a physical connection between the nodes. For example, the first-type edge may include an edge formed by the pathway of physical connection between the first facility nodes, etc. The second-type edge may correspond to an edge in which a physical connection exists between the enterprise node and the facility node or the pipeline node within a preset range.

The preset range may be within a preset radius with the enterprise node as the center. The preset radius may be preset by those skilled in the art according to experience. An edge attribute may reflect a relevant feature of the pathway corresponding to the physical connection. For example, the edge attribute of the first-type edge and the edge attribute of the second-type edge may include a distance between nodes.

In some embodiments, the first-type edge may be a directed edge and the second-type edge may be an undirected edge. A direction of the directed edge may be a direction of gas flow.

The reference feature map refers to an emergency safety simulation feature map constructed based on historical gas regulatory information, historical hazard feedback information, and historical personnel information of the region to be stimulated. The reference feature map is constructed in a way same as the way in which the emergency feature map is constructed.

The simulation parameter database may include a plurality of reference feature maps. Each reference feature map has at least one reference simulation parameter corresponding to a historical simulation region.

In some embodiments, the at least one reference simulation parameter may be customized by those skilled in the art according to actual conditions of the historical simulation region corresponding to the reference feature map.

In some embodiments, the at least one reference simulation parameter may also be at least one historical emergency safety simulation parameter of historical emergency safety simulation parameters whose evaluation scores satisfy a first preset condition and that are screened out from a plurality of historical emergency safety simulation parameters corresponding to the reference feature map of the regulatory region. The first preset condition may be that the evaluation score of the historical emergency safety simulation parameter is smaller than a score threshold. The score threshold may be preset by those skilled in the art according to experience.

The evaluation score may reflect a degree of matching between the emergency safety simulation parameter and the regulatory region. For example, the larger the evaluation score, the higher the degree of matching between the emergency safety simulation parameter and the regulatory region. In some embodiments, the evaluation score may be expressed as a numerical value within 0-100. The larger the numerical value, the larger the evaluation score.

In some embodiments, the gas company management platform may adjust, based on an emergency safety simulation result corresponding to the historical emergency safety simulation parameters, a warning level of a warning device; monitor, based on the adjusted warning level, a count of missed judgments of the warning device; and determine, based on the count of missed judgments of the warning device, the evaluation score of the historical emergency safety simulation parameters. For example, the smaller the count of missed judgments, the larger the evaluation score of the historical emergency safety simulation parameters.

In some embodiments, the gas company management platform may construct the emergency feature map based on the gas regulatory information, the hazard feedback information, and the personnel information corresponding to the regulatory region to be simulated; determine, based on the emergency feature map and the first candidate simulation parameter, the evaluation score of the first candidate simulation parameter through a simulation parameter evaluation model; and determine, based on the evaluation score, the emergency safety simulation parameters corresponding to different regulatory regions.

More descriptions regarding the constructing the emergency feature map and determining the first candidate simulation parameter may be found above.

In some embodiments, the simulation parameter evaluation model may be a machine learning model. In some embodiments, a type of the simulation parameter evaluation model may include a graph neural networks (GNN) model.

In some embodiments, the simulation parameter evaluation model may be trained by a large number of first training samples with first training labels.

In some embodiments, each set of first training samples of the first training samples may include a historical sample emergency feature map and a historical sample emergency safety simulation parameter. In some embodiments, the first training samples may be obtained based on historical data.

In some embodiments, the first training label may be an evaluation scores corresponding to the historical sample emergency safety simulation parameter. The gas company management platform may obtain, by performing a simulation drill on the historical sample emergency safety simulation parameter, a historical sample emergency safety simulation result, adjust the warning level of the warning device, and perform the simulation drill again. The larger the response speed of the warning device (e.g., the shorter the average response time) is, or the higher the quality of emergency safety simulation is when a fault actually occurs, the larger the evaluation score of the corresponding historical emergency safety simulation parameter may be.

In some embodiments, the gas company management platform may input the historical sample emergency feature map and the historical sample emergency safety simulation parameter of the first training samples with the first training labels into an initial simulation parameter evaluation model. The gas company management platform may construct a loss function through the first training labels and prediction results of the initial simulation parameter evaluation model. The gas company management platform may also iteratively update parameters of the initial simulation parameter evaluation model based on the loss function until the loss function converges, a count of iterations reaches a threshold, the training may be completed, and a trained simulation parameter evaluation model may be obtained.

In some embodiments, in response to a determination that an evaluation score of at least one first candidate simulation parameter is greater than or equal to the score threshold, the gas company management platform may select a first candidate simulation parameter with a highest evaluation score as the emergency safety simulation parameter corresponding to the selected regulatory region. The score threshold refers to a critical value of the evaluation score, which may be preset by those skilled in the art according to experience.

In some embodiments, in response to a determination that an evaluation score of each first simulation parameter of the at least one first simulation parameter is smaller than the score threshold, the gas company management platform may determine emergency safety simulation parameters corresponding to the plurality of regulatory regions using the following operation 340-operation 370.

In 340, a value range of the emergency safety simulation parameters may be determined.

In some embodiments, the value range of the emergency safety simulation parameters may be preset by those skilled in the art according to experience.

In some embodiments, the gas company management platform may determine the value range of the emergency safety simulation parameters based on historical data. For example, a largest count of personnel assigned to a post in the historical data of sub-region 1 may be used as an upper limit of the value range of the count of personnel of the post, and a smallest count of personnel assigned to the post may be used as a lower limit of the value range of count of personnel of the post.

In 350, at least one second candidate simulation parameter may be generated based on the value range.

The second candidate simulation parameter refers to an emergency safety simulation parameter that falls within the value range of emergency safety simulation parameters.

In some embodiments, the gas company management platform may randomly select at least one second candidate simulation parameter from the value range of emergency safety simulation parameters.

In 360, an evaluation score of the second candidate simulation parameter may be determined based on the second candidate simulation parameter and the emergency feature map through the simulation parameter evaluation model.

In some embodiments, the gas company management platform may determine the evaluation score of the second candidate simulation parameter by inputting the second candidate simulation parameter and the emergency feature map of the regulatory region into the simulation parameter evaluation model.

In some embodiments, the gas company management platform may store the determined evaluation score of the second candidate simulation parameter.

In 370, a selected emergency safety simulation parameter may be determined based on the evaluation score of the second candidate simulation parameter.

In some embodiments, the gas company management platform may repeat a plurality of rounds of operation 350-operation 360. After determining a new evaluation score of a second candidate simulation parameter in each round, the gas company management platform may retain a second candidate simulation parameter with a largest evaluation score by comparing the new evaluation score of the second candidate simulation parameter with a previously determined evaluation score of the second candidate simulation parameter. When a preset count of searches is reached or a second candidate simulation parameter whose evaluation score satisfies a preset condition (e.g., the evaluation score is greater than the score threshold) is found, the gas company management platform may stop repeating operation 350-operation 360, and determine a second candidate simulation parameter determined in a last round as the selected emergency safety simulation parameter.

In some embodiments of the present disclosure, the gas company management platform may retrieve and determine the at least one first candidate simulation parameter in the simulation parameter database through the emergency feature map. The gas company management platform may determine the evaluation score of the at least one first candidate simulation parameter through the simulation parameter evaluation model, and screen out the at least one first candidate simulation parameter whose evaluation score is greater than or equal to the score threshold. The gas company management platform may select the first candidate simulation parameter with the largest evaluation score as the emergency safety simulation parameter corresponding to the selected regulatory region, so as to automatically determine the optimal emergency safety simulation parameter.

In addition, when the first candidate simulation parameter whose evaluation score is greater than or equal to the score threshold cannot be screened out through the simulation parameter database, the second candidate simulation parameter whose evaluation score is greater than or equal to the score threshold may also be selected based on the value range of the emergency safety simulation parameters as the emergency safety simulation parameter corresponding to the selected regulatory region to further improve the accuracy of the determined emergency safety simulation parameter.

FIG. 4 is an exemplary schematic diagram illustrating predicting potential emergency hazards of the plurality of regulatory regions according to some embodiments of the present disclosure.

In some embodiments, the gas company management platform may determine, through a potential hazard determination model 420, the potential emergency hazards 430 of the plurality of regulatory regions based on gas regulatory information 410-1, external environmental data 410-2, gas pipeline data 410-3, and equipment installation data 410-4.

The external environmental data 410-2 refers to information related to an external environment of the regulatory region.

In some embodiments, the external environmental data 410-2 may include at least one of meteorological data (e.g., temperature, barometric pressure, humidity, etc.) of the regulatory region.

In some embodiments, the external environmental data 410-2 may be represented by a time-environment sequence. The time-environment sequence refers to a sequence including meteorological data corresponding to a plurality of time points of the regulatory region. For example, the time-environment sequence=(meteorological data at time c1, meteorological data at time c2, . . . , meteorological data at time cn), where c1, c2, and cn denotes different consecutive time points, and n is a positive integer.

In some embodiments, the gas pipeline data 410-3 may include at least one of a material, a diameter, a length, a pipeline position, etc. of the gas pipeline. The pipeline position may be represented by a preset serial number. The preset serial number of the pipeline position may be preset by those skilled in the art according to experience.

In some embodiments, the equipment installation data 410-4 may include at least one of an installation position, an age, a maintenance record, etc. of each gas equipment.

More descriptions regarding the gas regulatory information 410-1 may be found in the related description of operation 210 in FIG. 2.

In some embodiments, the potential hazard determination model 420 may be a machine learning model. In some embodiments, a type of the potential hazard determination model may include a Long Short-Term Memory (LSTM) network model.

In some embodiments, the potential hazard determination model may be obtained by training a large number of second training samples and a second training label corresponding to each second training sample.

In some embodiments, each set of second training samples in the second training samples may include historical sample gas regulatory information, historical sample external environmental data, historical sample gas pipeline data, and historical sample equipment installation data at a first time point. In some embodiments, the second training samples may be obtained based on historical data.

In some embodiments, the second label may be a point where failure/maintenance of the second training sample at the first time point actually occurs at a second time point. In some embodiments, the training label may be obtained by manual labeling. The first time point may be earlier than the second time point.

In some embodiments, the training process of the potential hazard determination model is similar to the training process of the simulation parameter evaluation model. More descriptions may be found in operation 330 of FIG. 3.

In some embodiments, the gas company management platform may obtain the potential emergency hazards of each regulatory region in the plurality of regulatory regions by inputting the gas regulatory information, the external environmental data, the gas pipeline data, and the equipment installation data of each regulatory region into a trained potential hazard determination model, respectively.

In some embodiments of the present disclosure, the potential emergency hazards may be quickly and accurately determined by the gas company management platform through the potential hazard determination model.

FIG. 5 is a flowchart illustrating an exemplary process for determining parameter optimization data of warning devices according to some embodiments of the present disclosure. In some embodiments, the process 500 may be performed by a government regulatory management platform of the IoT system for smart gas emergency safety simulation based on government regulation. As shown in FIG. 5, the process 500 may include following operation 510-operation 540.

In 510, an emergency safety simulation result sequence corresponding to emergency safety simulation parameters may be determined based on the simulation monitoring data.

More descriptions regarding the simulation monitoring data and the emergency safety simulation parameters may be found in the relevant descriptions in FIG. 2.

The emergency safety simulation result sequence refers to a sequence of a plurality of emergency safety simulation results. More descriptions regarding the emergency safety simulation results may be found in the relevant descriptions of operation 270 in FIG. 2. For example, the emergency safety simulation result sequence may be a sequence composed of a response time of troubleshooting, a response time of personnel evacuation, and a response time of warning.

In some embodiments, the emergency safety simulation result sequence may include an emergency safety simulation result sequence of each sub-region in a plurality of regulatory regions.

The emergency safety simulation result sequence of the sub-region refers to a sequence composed of a plurality of emergency safety simulation results of the sub-region.

In some embodiments, the government regulatory management platform may determine, based on the simulation monitoring data, the plurality of emergency safety simulation results corresponding to the emergency safety simulation parameters, and determine, based on the plurality of emergency safety simulation results, the emergency safety simulation result sequence.

In 520, a quality of emergency safety simulation of each sub-region in the plurality of regulatory regions may be determined based on the emergency safety simulation result sequence.

In some embodiments, the government regulatory management platform may determine the quality of emergency safety simulation of the regulatory region based on the response time of personnel evacuation, the response time of troubleshooting, and the response time of warning in the emergency safety simulation result sequence. More descriptions regarding the quality of emergency safety simulation and the manner for determining the quality of emergency safety simulation, may be found in the descriptions of operation 270 in FIG. 2.

In 530, a warning feature map may be constructed based on the quality of emergency safety simulation of each sub-region in the plurality of regulatory regions, the potential emergency hazards, and the hazard feedback information.

More descriptions regarding the potential emergency hazards and the hazard feedback information may be found in the relevant descriptions in FIG. 2.

The warning feature map refers to a map constructed by the quality of emergency safety simulation, the potential emergency hazards, and the hazard feedback information of the regulatory region.

In some embodiments, the warning feature map refers to a data structure composed of nodes and edges. The edges may connect the nodes, and the nodes and the edges may have attributes.

In some embodiments, a node of the warning feature map may correspond to a sub-region of the region to be stimulated. The manner for dividing the sub-region is the same as the manner for dividing the sub-region of the emergency feature map. More descriptions may be found in operation 330 in FIG. 3.

In some embodiments, a type of node of the warning feature map may include a first enterprise node, a second facility node, and a second pipeline node.

In some embodiments, the second facility node may be similar to the first facility node in the emergency feature map. The second facility node attribute may include all attributes of the first facility node in the emergency feature map. The second facility node attribute may further include the quality of emergency safety simulation of the sub-region corresponding to the second facility node, the warning device, and current operation parameters corresponding to the warning device, etc.

In some embodiments, the second pipeline node may be similar to the first pipeline node in the emergency feature map. The second pipeline node attribute may include all attributes of the first pipeline node in the emergency feature map. The second pipeline node attribute may further include the warning device of the sub-region corresponding to the second pipeline node and corresponding current operation parameters corresponding to the warning device, the quality of emergency safety simulation, etc.

More descriptions regarding all the attributes of the first enterprise node, the first facility node, and all the attributes of the first pipeline node in the emergency feature map may be found in the descriptions of the emergency feature map of operation 330 in FIG. 3.

In some embodiments, the edges of the warning feature map may be similar to the edges of the emergency feature map. More descriptions may be found operation 330 in FIG. 3.

In 540, the parameter optimization data of the warning devices may be determined through an optimization parameter determination model based on the warning feature map.

In some embodiments, the optimization parameter determination model may be a machine learning model. In some embodiments, a type of the optimization parameter determination model may include a Graph Neural Networks (GNN) model.

In some embodiments, an input of the optimization parameter determination model may include the warning feature map, and an output of the optimization parameter determination model may include the parameter optimization data of the warning devices corresponding to the nodes of the warning feature map.

More descriptions regarding the warning devices and the parameter optimization data of the warning devices may be found in the relevant description of operation 270 in FIG. 2.

In some embodiments, the optimization parameter determination model may be obtained by training based on training samples and training labels corresponding to the training samples.

In some embodiments, the training samples may include sample warning feature maps, and the training labels may include parameter optimization data of warning devices corresponding to nodes of the sample warning feature maps.

In some embodiments, the gas company management platform may construct the sample warning feature maps based on the quality of emergency safety simulation, the potential emergency hazards, and the hazard feedback information of a historical sample regulatory region. The quality of emergency safety simulation, the potential emergency hazards, and the hazard feedback information of the historical sample regulatory region may be obtained based on historical data.

In some embodiments, the gas company management platform may obtain the training labels by setting a plurality of sets of parameter optimization data of the warning devices for the training samples, and selecting parameter optimization data of a warning device with a highest actual adjustment score from the parameter optimization data as the training labels.

The actual adjustment score may reflect whether the parameter optimization data improves the quality of emergency safety simulation. For example, the larger the actual adjustment score is, the more the quality of emergency safety simulation may be improved. More descriptions regarding the quality of emergency safety simulation, may be found in the descriptions of operation 270 in FIG. 2.

In some embodiments, the gas company management platform may determine the actual adjustment score by obtaining a sequence difference of the warning devices when an actual emergency safety simulation drill is performed. The sequence difference refers to a difference between an emergency safety simulation result sequence corresponding to parameter optimization data before the parameter optimization data is adjusted and an emergency safety simulation result sequence corresponding to parameter optimization data after the parameter optimization data is adjusted. For example, compared with the quality of emergency safety simulation corresponding to the emergency safety simulation result sequence before the parameter optimization data of the warning devices is adjusted, the more the quality of emergency safety simulation corresponding to the emergency safety simulation result sequence after the parameter optimization data of the warning devices is adjusted is increased, the larger the actual adjustment score may be.

In some embodiments, the government regulatory management platform may obtain the actual adjustment score by performing, according to a degree of importance of the sub-regions in the region to be simulated, a weighted summation on increments in the quality of emergency safety simulation corresponding to the emergency safety simulation result sequence after the parameter optimization data of the warning device is adjusted compared with the quality of emergency safety simulation corresponding to the emergency safety simulation result sequence before the parameter optimization data of the warning device is adjusted.

Merely by way of example, the actual adjustment score may be expressed using the following fourth equation:

Actual adjustment score=c1*increment of quality of emergency safety simulation of sub-region 1+c2*increment of the quality of emergency safety simulation of sub-region 2 . . . +cn*the increment of the quality of emergency safety simulation of sub-region n,

where n is any positive integer, and c1, c2, . . . , cn are any numerical values greater than 0 and smaller than 1, which are preset by those skilled in the art according to experience. In some embodiments, c 1, c2, . . . , cn may be positively correlated with the degree of the importance of the sub-region. The degree of importance of each sub-region may be preset in advance by those skilled in the art.

In some embodiments, during training of the optimization parameter determination model, a weight of a degree of influence of each training sample on a loss function may be positively correlated with the actual adjustment score corresponding to the training label. Understandably, the greater the weight of the degree of influence of the training sample on the loss function is, the greater the contribution of the training sample to the training of the optimization parameter determination model.

In some embodiments of the present disclosure, the weight of the degree of influence of each training sample on the loss function may be set to be positively correlated with the actual adjustment score corresponding to the training label, so that the optimization parameter determination model may try to learn in a direction of parameter optimization data of the warning device with a highest actual adjustment score when the sample size is not sufficient, thereby improving the accuracy of the prediction of the optimization parameter determination model obtained by training.

In some embodiments, the government regulatory management platform may input the warning feature maps into a trained optimization parameter determination model and output the parameter optimization data of the warning devices corresponding to the nodes of the warning feature maps.

In some embodiments of the present disclosure, the parameter optimization data of the warning devices may be determined by inputting the constructed warning feature maps into the optimization parameter determination model, which further improves the accuracy of the determined parameter optimization data of the warning devices.

Having thus described the basic concepts, it may be rather apparent to those skilled in the art after reading this detailed disclosure that the foregoing detailed disclosure is intended to be presented by way of example only and is not limiting.

What is claimed is:

1. A method for smart gas emergency safety simulation based on government regulation, implemented by an Internet of Things (IoT) system for smart gas emergency safety simulation based on government regulation, the IoT system including a gas company management platform, a gas company service platform, a gas equipment object platform, a gas user platform, and a government regulatory management platform, wherein the method comprises:
obtaining, by the gas company management platform, gas regulatory information of a plurality of regulatory regions through the gas equipment object platform;
predicting, by the gas company management platform, potential emergency hazards of the plurality of regulatory regions based on the gas regulatory information, and sending the potential emergency hazards to the gas user platform through the gas company service platform;
obtaining, by the gas company management platform, hazard feedback information corresponding to the potential emergency hazards through the gas user platform;
determining, by the gas company management platform, emergency safety simulation parameters corresponding to the plurality of regulatory regions based on the hazard feedback information and the gas regulatory information, the emergency safety simulation parameters including arrangement parameters of emergency safety simulation personnel and operation parameters of emergency safety simulation equipment in the plurality of regulatory regions;
sending, by the gas company management platform, the emergency safety simulation parameters to the gas user platform to instruct the gas user platform to adjust the operation parameters of the emergency safety simulation equipment and sending emergency safety simulation notifications to the emergency safety simulation personnel through the emergency safety simulation equipment;
obtaining, by the gas company management platform, simulation monitoring data collected by the emergency safety simulation equipment through the gas equipment object platform, the emergency safety simulation equipment performing an emergency safety simulation process;
determining, by the gas company management platform, an emergency safety simulation result corresponding to the emergency safety simulation parameters based on the simulation monitoring data, and sending the emergency safety simulation result to the government regulatory management platform, wherein
the government regulatory management platform determines parameter optimization data of warning devices based on the emergency safety simulation result and the potential emergency hazards, and sends the parameter optimization data to gas companies corresponding to the plurality of regulatory regions to instruct the gas companies to adjust parameters of the warning devices in the plurality of regulatory regions.

2. The method of claim 1, wherein the IoT system further includes a government regulatory object platform, a government regulatory sensing network platform, and a gas company sensing network platform;
the government regulatory object platform includes the gas company management platform;
the government regulatory management platform includes a government regulatory comprehensive database;
the gas regulatory information includes at least one of operation parameters of gas ancillary facilities, gas data, inspection and maintenance information, or status information of the emergency safety simulation equipment;
the operation parameters of gas ancillary facilities include operation parameters of pipeline regulating devices or monitoring parameters of gas monitoring devices; and the emergency safety simulation result includes at least one of an emergency safety simulation result of relevant gas companies, an emergency safety simulation result of the gas ancillary facilities, or an emergency safety simulation result of segmented gas pipelines;
the gas equipment object platform is configured to obtain uploaded data of the gas ancillary facilities, and uploaded data of the gas monitoring devices installed in the segmented gas pipelines; the gas ancillary facilities include the pipeline regulating devices; and the gas ancillary facilities are configured to be communicatively connected to the emergency safety simulation equipment, and upload the status information of the emergency safety simulation equipment and the simulation monitoring data collected by the emergency safety simulation equipment to the gas company management platform;
the gas company service platform is configured to perform data interaction with the gas company management platform and the gas user platform;
the gas user platform is configured to be on the relevant gas companies and the emergency safety simulation equipment corresponding to the relevant gas companies, the gas user platform being configured to:
receive the potential emergency hazards and the emergency safety simulation parameters issued, through the gas company management platform, by the gas company service platform;
obtain the hazard feedback information of the potential emergency hazards and upload the hazard feedback information to the gas company management platform; and
adjust the operation parameters of the emergency safety simulation equipment based on the emergency safety simulation parameters, and send the emergency safety simulation notifications to the emergency safety simulation personnel through the emergency safety simulation equipment;
the government regulatory management platform is configured to receive the emergency safety simulation result uploaded by the gas company management platform, determine, based on the emergency safety simulation result of the plurality of regulatory regions and the potential emergency hazards of the plurality of regulatory regions, the parameter optimization data of the warning devices, and send the parameter optimization data to the gas companies corresponding to the plurality of regulatory regions to instruct the gas companies to adjust the parameters of the warning devices in the plurality of regulatory regions;
the government regulatory sensing network platform is configured to interact with the government regulatory comprehensive database and the gas company management platform; and
the gas company sensing network platform is configured to interact with the gas equipment object platform and the gas company management platform.

3. The method of claim 1, wherein the determining, by the gas company management platform, emergency safety simulation parameters corresponding to the plurality of regulatory regions based on the hazard feedback information and the gas regulatory information includes:
determining potential risk scores of the plurality of regulatory regions based on the potential emergency hazards, the hazard feedback information, and the gas regulatory information;
determining regions to be simulated based on the potential risk scores and a risk threshold; and
in response to a determination that an evaluation score of a first candidate simulation parameter is greater than or equal to a score threshold, determining, by the gas company management platform, the emergency safety simulation parameters corresponding to the plurality of regulatory regions based on the gas regulatory information, the hazard feedback information, personnel information, and the first candidate simulation parameter corresponding to the regions to be simulated.

4. The method of claim 3, wherein determining the risk threshold is related to a historical average failure frequency of the plurality of regulatory regions.

5. The method of claim 3, wherein in response to a determination that the evaluation score of the first candidate simulation parameter is smaller than the score threshold, the determining, by the gas company management platform, the emergency safety simulation parameters corresponding to the plurality of regulatory regions based on the hazard feedback information and the gas regulatory information further includes:
determining a value range of the emergency safety simulation parameters;
generating at least one second candidate simulation parameter based on the value range;
determining, based on the second candidate simulation parameter and an emergency feature map, an evaluation score of the second candidate simulation parameter through a simulation parameter evaluation model, the simulation parameter evaluation model being a machine learning model; and
determining a selected emergency safety simulation parameter based on the evaluation score of the second candidate simulation parameter.

6. The method of claim 3, wherein the predicting, by the gas company management platform, potential emergency hazards of the plurality of regulatory regions based on the gas regulatory information includes:
predicting, through a potential hazard determination model, the potential emergency hazards of the plurality of regulatory regions based on the gas regulatory information, external environmental data, gas pipeline data, and equipment installation data, the potential hazard determination model being a machine learning model.

7. The method of claim 1, wherein the government regulatory management platform determining parameter optimization data of warning devices based on the emergency safety simulation result and the potential emergency hazards includes:
determining an emergency safety simulation result sequence corresponding to the emergency safety simulation parameters based on the simulation monitoring data, the emergency safety simulation result sequence including an emergency safety simulation result sequence of each sub-region in the plurality of regulatory regions;
determining a quality of emergency safety simulation of each sub-region in the plurality of regulatory regions based on the emergency safety simulation result sequence;
constructing a warning feature map based on the quality of emergency safety simulation of each sub-region in the plurality of regulatory regions, the potential emergency hazards, and the hazard feedback information; and
determining, through an optimization parameter determination model, the parameter optimization data of the warning devices based on the warning feature map, the optimization parameter determination model being a machine learning model.

8. The method of claim 7, wherein the optimization parameter determination model is obtained by training based on training samples and training labels corresponding to the training samples;
the training samples include sample warning feature maps, the sample warning feature maps being constructed by actually collected data;
the training labels corresponding to the training samples are obtained by setting a plurality of sets of the parameter optimization data of the warning devices for the training samples and selecting parameter optimization data of a warning device with a highest actual adjustment score from the parameter optimization data as the training labels; and
during the training of the optimization parameter determination model, a weight of a degree of influence of the training samples on a loss function is positively correlated with an actual adjustment score corresponding to the training label, the actual adjustment score being determined by obtaining a sequence difference of the warning devices when an actual emergency safety simulation drill is performed, and the sequence difference being a difference between an emergency safety simulation result sequence corresponding to parameter optimization data before the parameter optimization data is adjusted and an emergency safety simulation result sequence corresponding to parameter optimization data after the parameter optimization data is adjusted.

9. An Internet of Things (IoT) system for smart gas emergency safety simulation based on government regulation, comprising a government regulatory management platform, a government regulatory sensing network platform, a government regulatory object platform, a gas company sensing network platform, a gas equipment object platform, a gas company service platform, and a gas user platform, wherein the government regulatory object platform includes a gas company management platform; the government regulatory management platform includes a government regulatory comprehensive database;
the gas equipment object platform is configured to obtain uploaded data of the gas ancillary facilities, and uploaded data of the gas monitoring devices installed in the segmented gas pipelines; the gas ancillary facilities include the pipeline regulating devices; and the gas ancillary facilities are configured to be communicatively connected to the emergency safety simulation equipment, and upload the status information of the emergency safety simulation equipment and the simulation monitoring data collected by the emergency safety simulation equipment to the gas company management platform;
the gas company service platform is configured to perform data interaction with the gas company management platform and the gas user platform;
the gas user platform is configured to be on the relevant gas companies and the emergency safety simulation equipment corresponding to the relevant gas companies, the gas user platform being configured to:
receive the potential emergency hazards and the emergency safety simulation parameters issued, through the gas company management platform, by the gas company service platform;
obtain the hazard feedback information of the potential emergency hazards and upload the hazard feedback information to the gas company management platform; and
adjust the operation parameters of the emergency safety simulation equipment based on the emergency safety simulation parameters, and send the emergency safety simulation notifications to the emergency safety simulation personnel through the emergency safety simulation equipment;
the government regulatory management platform is configured to receive the emergency safety simulation result uploaded by the gas company management platform, determine, based on the emergency safety simulation result of the plurality of regulatory regions and the potential emergency hazards of the plurality of regulatory regions, the parameter optimization data of the warning devices, and send the parameter optimization data to the gas companies corresponding to the plurality of regulatory regions to instruct the gas companies to adjust the parameters of the warning devices in the plurality of regulatory regions;
the government regulatory sensing network platform is configured to interact with the government regulatory comprehensive database and the gas company management platform; and
the gas company sensing network platform is configured to interact with the gas equipment object platform and the gas company management platform.

10. The IoT system of claim 9, wherein
the gas company management platform obtains gas regulatory information of a plurality of regulatory regions through the gas equipment object platform, the gas regulatory information includes at least one of operation parameters of gas ancillary facilities, gas data, inspection and maintenance information, or status information of the emergency safety simulation equipment, and the operation parameters of gas ancillary facilities include operation parameters of pipeline regulating devices or monitoring parameters of gas monitoring devices;
the gas company management platform predicts potential emergency hazards of the plurality of regulatory regions based on the gas regulatory information and sends the potential emergency hazards to the gas user platform through the gas company service platform;
the gas company management platform obtains hazard feedback information corresponding to the potential emergency hazards through the gas user platform;
the gas company management platform determines emergency safety simulation parameters corresponding to the plurality of regulatory regions based on the hazard feedback information and the gas regulatory information, the emergency safety simulation parameters including arrangement parameters of emergency safety simulation personnel and operation parameters of emergency safety simulation equipment in the plurality of regulatory regions;
the gas company management platform sends the emergency safety simulation parameters to the gas user platform to instruct the gas user platform to adjust the operation parameters of the emergency safety simulation equipment and sends emergency safety simulation notifications to the emergency safety simulation personnel through the emergency safety simulation equipment;
the gas company management platform obtains simulation monitoring data collected by the emergency safety simulation equipment through the gas equipment object platform, the emergency safety simulation equipment performing an emergency safety simulation process;
the gas company management platform determines an emergency safety simulation result corresponding to the emergency safety simulation parameters based on the simulation monitoring data and sends the emergency safety simulation result to the government regulatory management platform, and
the government regulatory management platform determines parameter optimization data of warning devices based on the emergency safety simulation result and the potential emergency hazards, and sends the parameter optimization data to gas companies corresponding to the plurality of regulatory regions to instruct the gas companies to adjust parameters of the warning devices in the plurality of regulatory regions.

11. The IoT system of claim 10, wherein the gas company management platform is further configured to:
determine potential risk scores of the plurality of regulatory regions based on the potential emergency hazards, the hazard feedback information, and the gas regulatory information;
determine regions to be simulated based on the potential risk scores and a risk threshold; and
in response to a determination that an evaluation score of a first candidate simulation parameter is greater than or equal to a score threshold, determine the emergency safety simulation parameters corresponding to the plurality of regulatory regions based on the gas regulatory information, the hazard feedback information, personnel information, and the first candidate simulation parameter corresponding to the regions to be simulated.

12. The IoT system of claim 11, wherein in response to a determination that the evaluation score of the first candidate simulation parameter is smaller than the score threshold, the gas company management platform is further configured to:
determine a value range of the emergency safety simulation parameters;
generate at least one second candidate simulation parameter based on the value range;
determine, based on the second candidate simulation parameter and an emergency feature map, an evaluation score of the second candidate simulation parameter through a simulation parameter evaluation model, the simulation parameter evaluation model being a machine learning model; and
determine a selected emergency safety simulation parameter based on the evaluation score of the second candidate simulation parameter.

13. The IoT system of claim 11, wherein the gas company management platform is further configured to:
predict, through a potential hazard determination model, the potential emergency hazards of the plurality of regulatory regions based on the gas regulatory information, external environmental data, gas pipeline data, and equipment installation data, the potential hazard determination model being a machine learning model.

14. The IoT system of claim 13, wherein determining the risk threshold is related to a historical average failure frequency of the plurality of regulatory regions.

15. The IoT system of claim 10, wherein the government regulatory management platform is further configured to:
determine an emergency safety simulation result sequence corresponding to the emergency safety simulation parameters based on the simulation monitoring data, the emergency safety simulation result sequence including an emergency safety simulation result sequence of each sub-region in the plurality of regulatory regions;
determine a quality of emergency safety simulation of each sub-region in the plurality of regulatory regions based on the emergency safety simulation result sequence;
construct a warning feature map based on the quality of emergency safety simulation of each sub-region in the plurality of regulatory regions, the potential emergency hazards, and the hazard feedback information; and
determine, through an optimization parameter determination model, the parameter optimization data of the warning devices based on the warning feature map, the optimization parameter determination model being a machine learning model.

16. The IoT system of claim 15, wherein the optimization parameter determination model is obtained by training based on training samples and training labels corresponding to the training samples;
the training samples include a sample warning feature map, the sample warning feature map being constructed by actually collected data;
the training labels corresponding to the training samples are obtained by setting a plurality of sets of the parameter optimization data of the warning devices for the training samples and selecting parameter optimization data of the warning devices with a highest actual adjustment score from the parameter optimization data as the training labels; and
during the training of the optimization parameter determination model, a weight of a degree of influence of the training samples on a loss function is positively correlated with an actual adjustment score corresponding to the training label, the actual adjustment score being determined by obtaining a sequence difference of the warning devices when an actual emergency safety simulation drill is performed, and the sequence difference being a difference between an emergency safety simulation result sequence corresponding to parameter optimization data before the parameter optimization data is adjusted and an emergency safety simulation result sequence corresponding to parameter optimization data after the parameter optimization data is adjusted.

17. A non-transitory computer-readable storage medium storing computer instructions, wherein when reading the computer instructions in the storage medium, a computer executes a method for smart gas emergency safety simulation based on government regulation.
